(19) United States
(12) Patent Application Publication
(10) Pub. No.: US 2006/0028210 A1
(43) Pub. Date: Feb. 9, 2006

(54) Electronic control unit monitoring device for a vehicle

(76) Inventors: Yo Yanagida, Shizuoka (JP); Naoyuki Shiraishi, Shizuoka (JP); Atsushi Kawamura, Shizuoka (JP); Terumitsu Sugimoto, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/183,759

(22) Filed: Jul. 19, 2005

(30) Foreign Application Priority Data
Jul. 21, 2004 (JP) 2004-212798

(51) Int. Cl. G01N 27/416

(52) U.S. Cl. 324/426

(57) ABSTRACT

An ECU monitoring device includes a driver's seat J/B ECU and an immobilizer ECU both connected to a main battery through a power line. In operation, the immobilizer ECU is formed so as to output a communication signal superimposed on the power line. While the driver's seat J/B ECU is formed so as to receive the communication signal from the power line. When the communication signal is not received by the driver's seat J/B ECU, it judges that the immobilizer ECU is disconnected from the power line on purpose or that a false instrument in place of the immobilizer ECU is connected to the power line falsely. In this way, the ECU monitoring device allows the driver's seat J/B ECU to monitor a connection between the power line and the immobilizer ECU to be monitored.

### BACKGROUND OF THE INVENTION

1. Field of the Invention

The present invention relates to a monitoring device for monitoring a connection between respective electronic control units (ECU) on a vehicle and power lines for supplying power to the ECU (ECU monitoring device hereinafter).

2. Description of the Related Art

Recently, there is a growing trend of vehicles equipped with antitheft systems (immobilizer systems) as measures for recent rash of stealing vehicles.

In general, an immobilizer system includes an ignition key having a transponder built-in, an immobilizer ECU, an engine ECU and so on. In operation, the immobilizer system is constructed so as to judge whether or not a vehicle is being used falsely by transmitting/receiving a code signal among the above constituents. Such a constitution is disclosed in Japanese Patent Publication Laid-open No. 8-30873.

However, if both or either one of the immobilizer ECU and the engine ECU is replaced by another instrument, then the immobilizer system breaks down. That is, it means that the immobilizer system cannot detect a vehicle being improperly used, so that it becomes impossible to protect the vehicle against theft.

In the situation, it has been desired to provide a system of detecting a point of time when either the immobilizer ECU or the engine ECU is detached from the vehicle falsely and further informing a passenger of the vehicle or its circumference of such a false detachment. As this type of system, various monitoring system shown in FIG. 1 is known conventionally.

In the monitoring system of FIG. 1, the junction box (J/B) ECU 101 is connected to the immobilizer ECU 102 through a CAN communication line L103. In operation, if the communication line L103 is connected between the junction box (J/B) ECU 101 and the immobilizer ECU 102 normally, then it is judged that the CAN communication is being performed normally. While, if the communication line L103 is cut off, it is judged that the immobilizer ECU 102 is detached from the system due to disrupture in communication.

However, since the above system adopts the standard protocol communication, there is the possibility that if the system is operated with the use of a commercial instrument falsely, it becomes impossible to detect that the immobilizer ECU 102 is detached.

As mentioned above, the conventional monitoring system for monitoring ECU has a drawback that it is impossible to detect that the immobilizer ECU 102 is detached from the system, with high accuracy.

### SUMMARY OF THE INVENTION

Under the circumstances, it is therefore an object of the present invention to provide an ECU monitoring device which is capable of detecting a situation that an immobilizer ECU is detached from a vehicle with high accuracy, thereby allowing an owner's vehicle to be protected against theft certainly.

The object of the present invention described above can be accomplished by an ECU monitoring device for monitoring connections between electronic control units on a vehicle, comprising: a main battery; at least one power line for connecting the main battery with the electronic control units thereby supplying the electronic control units with a power of the main battery; a first electronic control unit to be monitored, the first electronic control unit being formed by one of the electronic control units and having a first power multiplex transmitting unit for superimposing a first transmission signal on the power line and a first power multiplex receiving unit for receiving at least one transmission signal superimposed on the power line; and a second electronic control unit for monitoring the connection between the main battery and the first electronic control unit, the second electronic control unit being formed by another one of the electronic control units and having a second power multiplex transmitting unit for superimposing a second transmission signal on the power line and a second power multiplex receiving unit for receiving at least one transmission signal superimposed on the power line, wherein the second electronic control unit further includes a judging unit which is constructed so as to judge that the first electronic control unit is disconnected from the power line or that a false instrument in place of the first electronic control unit is connected to the power line falsely when the first transmission signal from the first power multiplex transmitting unit is not received by the second power multiplex receiving unit.

With the above-mentioned constitution, if a transmission signal outputted from the first electronic control unit to be monitored and superimposed on the power line is not received by the second electronic control unit, then the judging unit detects a situation that the first electronic control unit is disconnected from the power line. Therefore, with the operation of the judging unit, it becomes possible to prevent the vehicle from being stolen by thief.

According to the second aspect of the invention, in the above ECU monitoring device, the second power multiplex receiving unit of the second electronic control unit is formed with a receiving sensitivity whose sensing level is established somewhat smaller than a level of the first transmission signal outputted from the first power multiplex transmitting unit of the first electronic control unit and superimposed on the power line.

With the above-mentioned establishment in the receiving sensitivity of the second electronic control unit, if the level of a transmission signal superimposed on the power line drops as a result of connecting a false instrument to the power line, then it becomes impossible for the second electronic control unit to detect the above transmission signal. On detection of the impossibility of the second electronic control unit, it becomes possible to detect a false attachment of the informal instrument to the power line.

In the third aspect of the invention, the ECU monitoring device further comprises an alarm unit that generates an alarm signal when the judging unit of the second electronic control unit judges that the first electronic control unit is disconnected from the power line or that the false instrument in place of the first electronic control unit is connected to the power line falsely.

Then, owing to the provision of the alarm unit, it is possible to inform those around the vehicle of an execution of false manipulations certainly.

In the fourth aspect of the invention, the ECU monitoring device further comprises an engine electronic control unit for controlling a drive of an engine, wherein: the judging unit further stops a drive of the engine electronic control unit when the judging unit of the second electronic control unit judges that the first electronic control unit is disconnected from the power line or that the false instrument in place of the first electronic control unit is connected to the power line falsely.

With the arrangement mentioned above, if the false manipulations are detected, then the drive of the engine electronic control unit is stopped immediately. Under such a situation, a thief cannot drive a vehicle. That is, it is possible to improve the antitheft capability of the vehicle.

In the fifth aspect of the invention, the judging unit further stops the power supply of the main battery when the judging unit of the second electronic control unit judges that the first electronic control unit is disconnected from the power line or that the false instrument in place of the first electronic control unit is connected to the power line falsely.

In this case, as the power supply of the main battery is stopped on detection of false manipulations, anyone cannot drive a vehicle. In other words, it is possible to prevent the vehicle from being stolen by thief.

In the sixth aspect of the invention, the ECU monitoring device further comprises a backup battery that supplies the second electronic control unit with a driving power when the power supply from the main battery is shut off.

In this case, owing to the provision of the backup battery, even if the main battery is detached from the device falsely, it is possible to drive the second electronic control unit, so that false manipulations, such as detachment of ECU and attachment of false instruments, can be detected certainly.

In the seventh aspect of the invention, the first electronic control unit is an immobilizer electronic control unit for protect the vehicle against theft.

Then, with the establishment of the immobilizer electronic control unit as the first electronic control unit to be monitored, it is possible to reduce the possibility of a stealage of the vehicle remarkably.

These and other objects and features of the present invention will become more fully apparent from the following description and appended claims taken in conjunction with the accompanying drawings.

### BRIEF DESCRIPTION OF THE DRAWINGS

FIG. 1 is a block diagram showing the constitution of an ECU monitoring device in a conventional art;

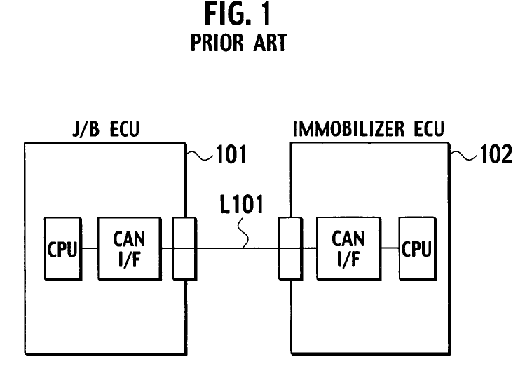

FIG. 2 is a block diagram showing the constitution of an ECU monitoring device in accordance with an embodiment of the present invention;

FIG. 3 is a block diagram showing the constitution of an electronic control unit (ECU) forming the device of FIG. 2;

FIG. 4 is a flow chart showing the operation of the ECU monitoring device in accordance with the embodiment of the present invention;

FIG. 5 is a timing chart showing the changes of respective signals when an immobilizer ECU is detached from a power line; and

FIG. 6 is a timing chart showing the change of the respective signals when a false instrument is attached to the power line.

### DESCRIPTION OF THE PREFERRED EMBODIMENT

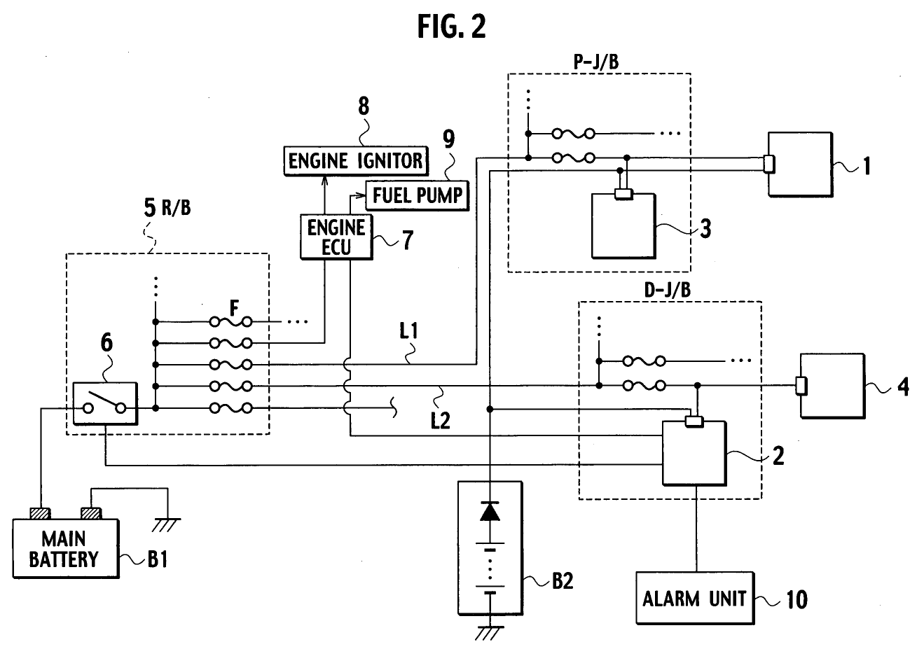

An embodiment of the present invention will be described with reference to the accompanying drawings. FIG. 2 is a block diagram showing the constitution of a power superposition-and-multiplex communication system including an ECU monitoring device of an embodiment of the present invention.

As shown in FIG. 2, the power superposition-and-multiplex communication system includes a plurality of electronic control units (ECU), in detail, an instrument panel ECU 1, a driver's seat junction box (J/B) ECU 2, a passenger's seat J/B ECU 3 and an immobilizer ECU 4. These ECUs 1 to 4 are connected to a main battery B1 mounted on a vehicle (not shown) through power lines L1 and L2.

The main battery B1 supplies the respective ECUs 1 to 4 with drive power. In operation, transmission signals are superimposed on the power lines L1, L2, allowing data combination among the respective ECUs 1 to 4.

In the main battery B1, its positive terminal is provided with a relay box 5 for allowing the positive terminal to branch out to a plurality of routes. The relay box 5 includes a power-off device 6 for interrupting the power supply of the main battery B1 forcibly and fuses F for respective power lines branched out.

The power line L1 diverged from the relay box 5 is connected to the passenger's seat J/B ECU 3 and the instrument panel ECU 1, while the power line L2 is connected to the driver's seat J/B ECU 2 and the immobilizer ECU 4.

A power line L3 diverged from the relay box 5 is connected to an engine ECU 7 for controlling the drive of an engine of the vehicle. The engine ECU 7 is mainly provided to control the operations of an engine ignition unit (ignitor) 8 and a fuel pump 9.

In addition to the main battery B1, the system is equipped with a backup battery B2. The backup battery B2 is also connected to the instrument panel ECU 1, the driver's seat J/B ECU 2 and the passenger's seat J/B ECU 3 and supplies these units 1, 2 and 3 with backup powers when the power supply of the main battery B1 is cut off. Again, the driver's seat J/B ECU 2 is further, connected to an alarm unit 10.

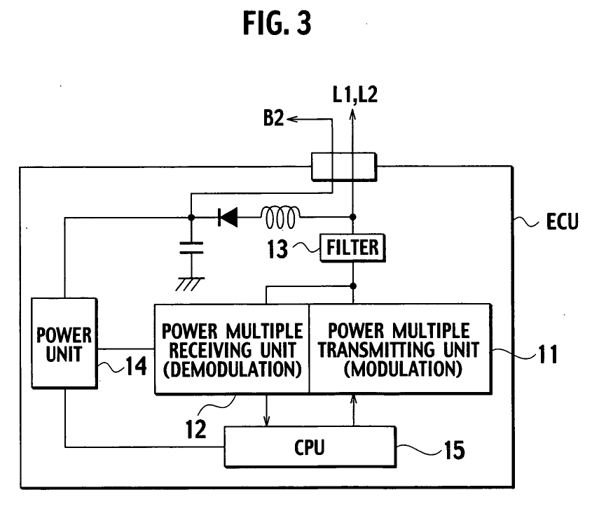

FIG. 3 is a block diagram showing the detailed structure of each of the ECUs 1 to 4. As shown in this figure, each of the ECUs 1 to 4 includes a power multiple transmitting unit 11 for outputting transmission signals superimposed on the power lines L1, L2, a power multiple receiving unit 12 for receiving the transmission signals superimposed on the power lines L1, L2 and a CPU 15 for controlling the transmission by the power multiple transmitting unit 11 and the reception by the power multiple receiving unit 12. By judging whether or not a transmission signal from an ECU to be monitored been received on a basis of a signal by the power multiple receiving unit 12, the CPU 15 further judges whether or not the ECU to be monitored is connected to the power line L1 (or L2). Note, the backup battery B2 is not connected to the immobilizer ECU 4 because it needs no power supply from the battery B2.

The power multiple receiving unit 12 has its receiving sensitivity established lower than a level of the transmission signal transmitted from each of the ECUs 1 to 4, which will be mentioned later. Therefore, if it is in a normal state, the power multiple receiving unit 12 is capable of receiving a transmission signal superimposed on the power line L1 (L2). However, if the level of a transmission signal superimposed on the power line L1 (L2) has dropped for some reasons, the power multiple receiving unit 12 cannot receive the signal.

Further, each of the ECU 1 to 4 includes a power unit 14 for converting a power-supply voltage supplied from the backup battery B2 to a desired level of voltage to supply constituents of the ECU with a driving voltage, and a filter 13 for removing unnecessary frequency components from the transmission signal and the receiving signal.

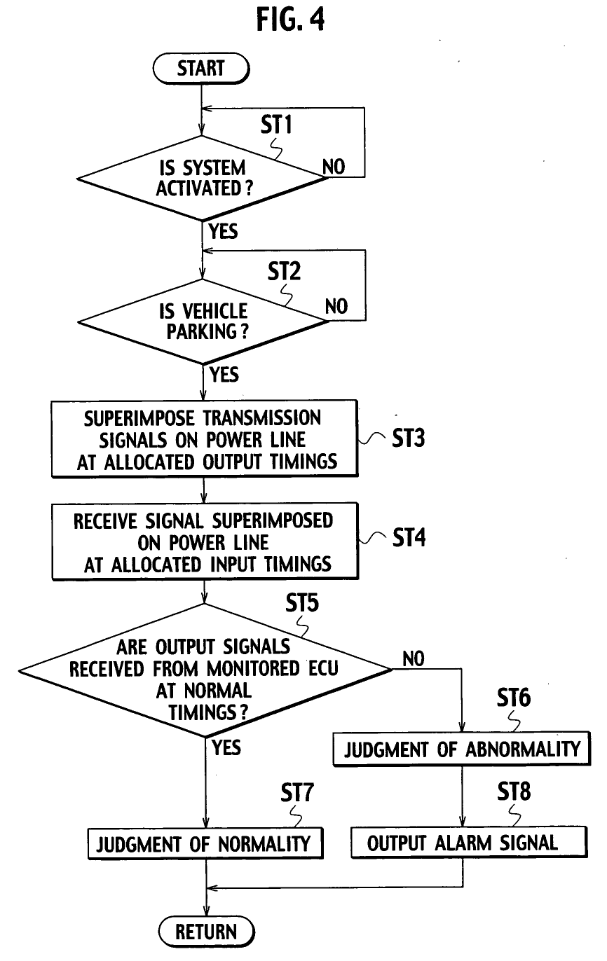

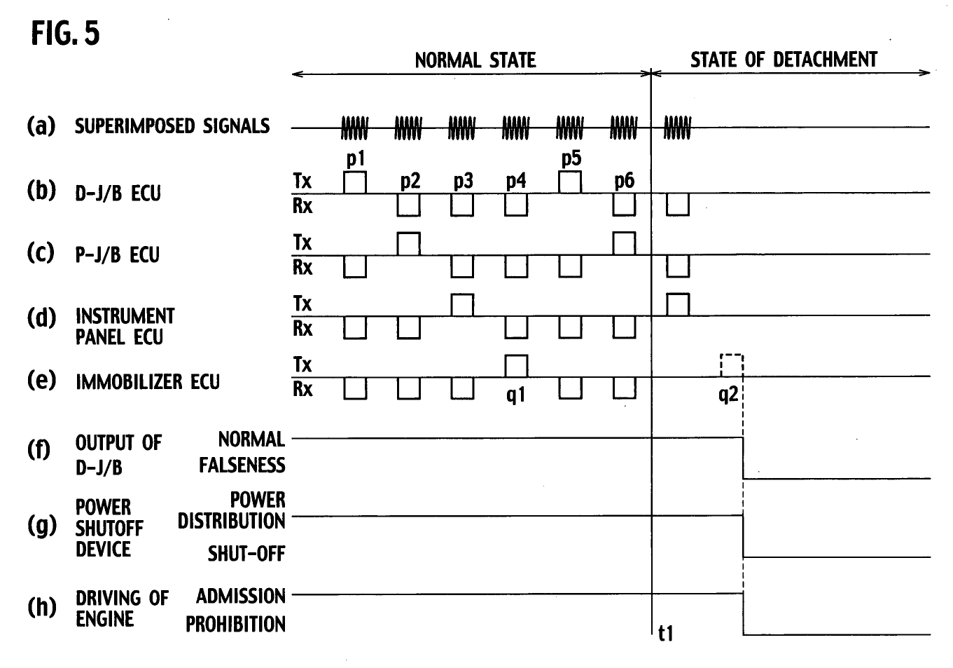

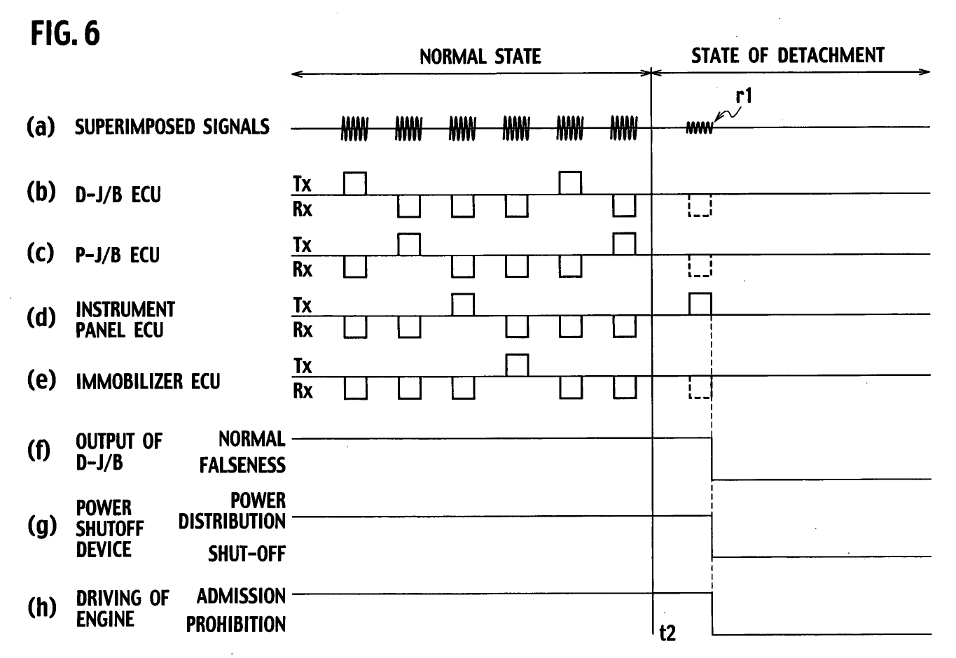

The operation of the ECU monitoring device of the embodiment will be described with reference to FIGS. 4, 5 and 6. FIG. 4 is a flow chart explaining the operation of the ECU monitoring device. FIGS. 5 and 6 are timing chart explaining the operation of the ECU monitoring device. Note, in this embodiment mentioned below, the immobilizer ECU 4 takes charge of an ECU to be monitored (i.e. the first electronic control unit of the invention) while establishing the driver's seat J/B ECU 2 as an ECU in charge of monitoring (i.e. the second electronic control unit of the invention).

Of course, as representatively shown in FIG. 3, the immobilizer ECU 4 is also provided with the power multiple transmitting unit 11 (i.e. the first power multiple transmitting unit of the invention) and the power multiple receiving unit 12 (i.e. the first power multiple receiving unit of the invention). Similarly, the driver's seat J/B ECU 2 is also provided with the power multiple transmitting unit 11 (i.e. the second power multiple transmitting unit of the invention) and the power multiple receiving unit 12 (i.e. the second power multiple receiving unit of the invention).

In FIG. 4, when the system is activated, in other words, if the judgment at step ST1 is Yes, then the routine goes to step ST2 where it is judged whether a vehicle is now parking or not. The judgment whether or not the vehicle is now parking is enabled by information about the operation of the engine, which is brought from the engine ECU 7.

If the vehicle is parking (Yes at step ST2), then the routine goes to step ST3 where power superposition-and-multiplex communications among the ECUs 1 to 4 are carried out at the predetermined timings.

FIG. 5 shows the changes of respective signals when the immobilizer ECU 4 in the normal state is disconnected from the power line L2 at time t2. As shown in FIG. 5 (b) to (e), in the embodiment, the operational modes of the driver's seat J/B ECU 2, the passenger's seat J/B ECU 3, the instrument panel ECU 1 and the immobilizer ECU 4 are each switched between its transmitting state and the receiving state at predetermined intervals, in this order. In the figure, alphabetical mark Tx designates transmissions of signals, while alphabetical mark Rx designates receipts of the signals. It should be noted that when one ECU is in the transmitting condition of a signal, the other ECUs (i.e. three units) are together in the receiving condition of signals. By repeating such transmitting/receiving conditions, the power superposition-and-multiplex communication system performs data communications among the ECUs 1 to 4.

Consequently, as shown in FIG. 5 (a), the transmission (communication) signals from the respective ECUs 1 to 4 are superimposed on the power lines L1, L2 at predetermined intervals. The communication signal outputted from each of the ECUs 1 to 4 contains an ID (identification) code for specifying the ECU as a sender.

At step ST3, the driver's seat J/B ECU 2 in charge of monitoring operation superimposes a transmission signal on the power lines L1, L2 at timings indicated with marks p1, p5 [see FIG. 5 (b)]. At next step ST4, the driver's seat J/B ECU 2 receives signals superimposed on the power lines L1, L2 at timings indicated with marks p2, p3, p4 and p6 of FIG. 5.

On the other hand, the immobilizer ECU 4 to be monitored superimposes a transmission signal on the power lines L1, L2 at a timing indicated with marks q1 [see FIG. 5 (e)]. Therefore, at step ST5, the driver's seat J/B ECU 24 judges whether or nor the transmission signal has been received at a timing p4 corresponding to the timing q1. If the judgment at step ST5 is Yes, that is, when it is judged that the transmission signal has been received at the normal timing p4 and that the so-received signal contains the ID code of the immobilizer ECU 4, then the routine goes to step ST7 where it is judged that the immobilizer ECU 4 is connected to the power line L2 in the formal condition.

Meanwhile, if the immobilizer ECU 4 is detached from the power line L2 at time t1 of FIG. 5 by false manipulations, a transmission signal is not superimposed from the immobilizer ECU 4 onto the power line L1 at a point of time of mark q2 [see FIG. 5 (e)] any more. It means that, in such a case, the driver's seat J/B ECU 2 cannot input the transmission signal containing the ID code of the immobilizer ECU 4 at the timing q2 (No at step ST5). Then, the routine goes to step ST6.

At step ST6, it is executed for the CPU 15 of the driver's seat J/B ECU 2 to recognize that the immobilizer ECU 4 is disconnected from the power line L2 falsely. At next step ST8, as shown in FIG. 5 (f), a falseness detecting signal is generated from the driver's seat J/B ECU 2 to the alarm unit 10. Note, the alarm unit 3 may be in the form of operating an automotive horn audibly or lighting a winker lamp built in the vehicle visually.

Additionally, as shown in FIG. 5 (g), it may be executed to output a power-off signal to the power-off device 6, bringing the power supply of the main battery B1 to standstill. Further, it may be executed to output a prohibition signal to the engine ECU 7, bringing the driving of the engine to standstill. As a result, as it becomes impossible for anyone to operate the vehicle, it is possible to prevent the vehicle from being stolen.

FIG. 6 is a timing chart showing the changes of respective signals when another instrument (not shown) in place of the immobilizer ECU 4 is attached to the power line L1 (or L2) at time t2 informally.

From the figure, it will be understood that the output forms of the signals shown in FIG. 6 (a) to (h) are similar to those of FIG. 5 till a time t2. However, when such a false instrument is connected to the power line L1 (or L2) at the time t2, the level of a transmission signal superimposed on the lines L1, L2 drops due to a bypass condenser (not shown) of the false instrument.

In the power multiple receiving unit 12 of the driver's seat J/B ECU 2, as mentioned above, the receiving sensitivity is established somewhat lower than a level of the transmission signal in the normal state. Therefore, if the level of the so-dropped transmission signal from the false instrument is smaller than the somewhat-lowered level established as a threshold value in the unit 12, it cannot detect the transmission signal whose level is lowered as shown with mark r1 [see FIG. 6 (a)]. Note, the expression “somewhat-lowered level” means a threshold level that allows a transmission signal to be certainly received in a normal state where no false instrument is attached to the power line. Additionally, it means that even if a false instrument is attached to the power line so that the level of the transmission signal is lowered, the threshold level would not make it impossible to receive such a transmission signal of the false instrument.

In this way, since the above-mentioned establishment of the threshold level disenables the driver's seat J/B ECU 2 to receive the transmission signal superimposed from the other instrument onto the power lines L1, L2, the CPU 15 recognizes that the other instrument is connected to the power line L1 (or L2) falsely and further output a falseness detection signal to the alarm unit 10.

Consequently, as similar to the case of FIG. 5, the power-off device 6 is activated to cut off the power supply of the main battery B1 and additionally, the engine ECU 7 is brought to standstill. As a result, as it becomes impossible for anyone to operate the vehicle, it is possible to prevent the vehicle from being stolen.

In this way, according to the embodiment, it is detected whether or not the transmission signal from the immobilizer ECU 4 to be monitored is received by the driver's seat J/B ECU 2 for monitoring. If no transmission signal is received, then the driver's seat J/B ECU 2 outputs a falseness detecting signal on judgment that the immobilizer ECU 4 is disconnected from the power line L2. That is, when the immobilizer ECU 4 is detached from the device by false manipulations, it is possible to detect such falseness and output an alarm signal, preventing the vehicle from being stolen by thief.

Again, since the receiving sensitivity of the driver's seat J/B ECU 2 is established somewhat smaller than a level of the transmission signal outputted from the immobilizer ECU 4 and further superimposed on the power lines L1, L2, if the level of a transmission signal superimposed on the power line drops greatly as a result of connecting a false instrument to the power line L1 (or L2), then the driver's seat J/B ECU 2 becomes impossible to detect the so-dropped transmission signal. Consequently, on detection of the impossibility of the driver's seat J/B ECU 2, it becomes possible to detect a false attachment of the informal instrument to the power line, preventing a stealage of the vehicle.

According to the embodiment, owing to the provision of the alarm unit 10 generating an alarm signal in the form of operating an automotive horn or lighting a winker lamp built in the vehicle, it is possible to inform those around the vehicle of an execution of false manipulations certainly, improving the antitheft capability of the device furthermore.

Further, when the falseness detecting signal is detected, the power-off device 6 is activated to stop the power supply from the main battery B1 and furthermore, the control operation of the engine ECU 7 is also stopped. In such a case, anyone cannot drive the vehicle. Thus, it is possible to prevent the vehicle from being stolen by thief certainly.

Still further, owing to the provision of the backup battery B2, even if the main battery B1 is removed from the vehicle due to false manipulation, the monitoring operation of the driver's seat J/B ECU 2 can be maintained with high accuracy.

Again, it will be understood by those skilled in the art that the foregoing descriptions are nothing but one embodiment of the disclosed ECU monitoring device and the modifications. In addition to the above modifications, various changes and modifications may be made to the present invention without departing from the scope of the invention. For instance, the driver's seat J/B ECU 2 in charge of the monitoring ECU may be replaced by another electronic control unit, for example, the instrument panel ECU.

What is claimed is:

1. A monitoring device for monitoring a connection between electronic control units on a vehicle, comprising:
a main battery;
at least one power line for connecting the main battery with the electronic control units thereby supplying the electronic control units with a power of the main battery;
a first electronic control unit to be monitored, the first electronic control unit being formed by one of the electronic control units and having a first power multiplex transmitting unit for superimposing a first transmission signal on the power line and a first power multiplex receiving unit for receiving at least one transmission signal superimposed on the power line; and
a second electronic control unit for monitoring the connection between the main battery and the first electronic control unit, the second electronic control unit being formed by another one of the electronic control units and having a second power multiplex transmitting unit for superimposing a second transmission signal on the power line and a second power multiplex receiving unit for receiving at least one transmission signal superimposed on the power line,
wherein the second electronic control unit further includes a judging unit which is constructed so as to judge that the first electronic control unit is disconnected from the power line or that a false instrument in place of the first electronic control unit is connected to the power line falsely when the first transmission signal from the first power multiplex transmitting unit is not received by the second power multiplex receiving unit.

2. The monitoring device as claimed in claim 1, wherein:
the second power multiplex receiving unit of the second electronic control unit is formed with a receiving sensitivity whose sensing level is established smaller than a level of the first transmission signal outputted from the first power multiplex transmitting unit of the first electronic control unit and superimposed on the power line.

3. The monitoring device as claimed in claim 1, further comprising an alarm unit that generates an alarm signal when the judging unit of the second electronic control unit judges that the first electronic control unit is disconnected from the power line or that the false instrument in place of the first electronic control unit is connected to the power line falsely.

4. The monitoring device as claimed in claim 1, further comprising an engine electronic control unit for controlling a drive of an engine,
wherein the judging unit further stops a drive of the engine electronic control unit when the judging unit of the second electronic control unit judges that the first electronic control unit is disconnected from the power line or that the false instrument in place of the first electronic control unit is connected to the power line falsely.

5. The monitoring device as claimed in claim 1, wherein the judging unit stops the power supply of the main battery when the judging unit of the second electronic control unit judges that the first electronic control unit is disconnected from the power line or that the false instrument in place of the first electronic control unit is connected to the power line falsely.

6. The monitoring device as claimed in claim 1, further comprising a backup battery that supplies the second electronic control unit with a driving power when the power supply from the main battery is shut off.

7. The monitoring device as claimed in claim 1, wherein the first electronic control unit is an immobilizer electronic control unit for protect the vehicle against theft.
